(19) United States
(12) Patent Application Publication
(10) Pub. No.: US 2023/0067365 A1
(43) Pub. Date: Mar. 2, 2023

(54) CONNECTOR AND CONTAINMENT SYSTEM FOR A PORTABLE FREE-STANDING SKATING RINK

(71) Applicants: Dylan Gastel, Boston, MA (US); Jason Stricker, West Newton, MA (US)

(72) Inventors: Dylan Gastel, Boston, MA (US); Jason Stricker, West Newton, MA (US)

(73) Assignee: Dylan Gastel, Boston, MA (US)

(21) Appl. No.: 17/896,540

(22) Filed: Aug. 26, 2022

Related U.S. Application Data
(60) Provisional application No. 63/239,058, filed on Aug. 31, 2021.

(51) Int. Cl. F16B 5/00; A63C 19/10

(52) U.S. Cl. CPC F16B 5/0036; A63C 19/10

(57) ABSTRACT

A connector for removably securing and stacking perimeter components of a skating rink includes an elongated body that extends extending an overall length from a first end to a second end thereof, the overall length is selected to span across a portion or all of each of two or more perimeter components. The connector includes two or more first anchoring features each extending a portion of or all of the overall length into or along a first lateral side of the elongated body. The connector includes two or more second anchoring features each extending a portion of or all of the overall length into or along a second lateral side of the elongated body. The second lateral side faces opposite to the first lateral side.

### CROSS REFERENCE TO RELATED APPLICATIONS

The present application is a non-provisional application of, and claims priority to, commonly owned and co-pending U.S. Provisional Patent Application No. 63/239,069, filed Aug. 31, 2021, the contents of which are incorporated herein by reference in its entirety.

### TECHNICAL FIELD

The present invention is directed to a connector and containment system for a portable free-standing skating rink and more particularly to a connector for aligning, removably joining and vertically stacking and stabilizing multiple perimeter components.

### BACKGROUND

Ice hockey and ice skating in general are increasingly popular in cold climates. The demand for ice time is so high compared with supply in many regions that teams and other clubs/groups must rent ice time during very early morning hours or very late nighttime hours. Many programs, especially those run by public high schools have been forced to reduce practice ice time hours or even eliminate entire programs due to increased costs to obtain ice time, particularly in view of reduced budgets.

Traditionally, hockey players and other skaters have used frozen lakes or ponds on which to skate during the winter months. In addition, families, towns, and other associations have flooded fields or parking lots to form ice on which to skate. Skating on lakes and ponds can be extremely dangerous. Also, flooding a permeable field or lot is not feasible in regions where the ice will melt and then refreeze throughout the winter, as the water will drain once the ice intermittently melts.

There are presently many complicated methods for constructing an outdoor ice rink. These usually involve constructing some sort of perimeter inside of which an impermeable liner is optionally laid. This open-top container is then partially filled with water, which freezes into ice in the rough shape of an ice rink. These perimeters are usually constructed of some combination of plywood, lumber, spikes, stakes, screws, and nails. Moreover, these perimeters are usually of limited height (e.g., one to two feet tall) which does not suffice to contain pucks that have high projectile paths and do not provide a suitable containment wall for ice skaters. In hockey checking is a move wherein a player drives the shoulder, upper arm and hip and elbow, equally into the opponent to separate them from the puck or using the body to knock an opponent against the boards. The perimeters of prior art a portable, free-standing ice skating rinks are too short to provide a wall for checking an opponent into the boards.

It is apparent from the above that there is a need for an improved portable, free-standing skating rink that can be constructed with suitable containment systems.

### SUMMARY

The present invention includes a connector for removably securing and stacking perimeter components of a skating rink includes an elongated body that extends extending an overall length from a first end to a second end thereof, the overall length is selected to span across a portion or all of each of two or more perimeter components. The connector includes two or more first anchoring features each extending a portion of or all of the overall length into or along a first lateral side of the elongated body. The connector includes two or more second anchoring features each extending a portion of or all of the overall length into or along a second lateral side of the elongated body. The second lateral side faces opposite to the first lateral side.

### BRIEF DESCRIPTION OF THE DRAWINGS

FIG. 1 is a front view of a pair of perimeter components shown disconnected from one another;

FIG. 2 is a front view of the pair of perimeter components of FIG. 1 shown joined to one another;

FIG. 3A is front cross-sectional view of a connector of the present invention;

FIG. 3B is front cross-sectional view of another embodiment or a connector of the present invention;

FIG. 3C is a front cross-sectional view of another embodiment of a connector of the present invention shown with gaps thereon;

FIG. 3D is a front cross-sectional view of another embodiment of a connector of the present invention shown with gaps thereon;

FIG. 3E is a full top cross-sectional view of the connector of FIG. 3A taken across section 3B-3B;

FIG. 4A is a front view of the connector of FIG. 3A connecting three stacked pairs of perimeter components;

FIG. 4B is a front view of a portion of the connector of FIG. 3A connecting three stacked pairs of perimeter components;

FIG. 5 is an alternate embodiment of the connector of the present invention;

FIG. 6 is an alternate embodiment of the connector of the present invention;

FIG. 7A is a top cross-sectional view of another connector of the present invention shown joining a pair of perimeter components;

FIG. 7B is a side view of the connector of FIG. 7A taken across section 7B-7B of FIG. 7A;

FIG. 7C is cross sectional view of the connector of FIG. 7A taken across section 7C-7C of FIG. 7A;

FIG. 7D is a cross sectional view of a hybrid connector having cross sections of both FIGS. 3A and 7C on portions thereof; and

FIG. 7E is a cross sectional view of a hybrid connector having cross sections of both FIGS. 3A and 7C on portions thereof.

FIG. 8A is a top cross-sectional view of another connector of the present invention shown joining a pair of perimeter components;

FIG. 8B is a side view of the connector of FIG. 8A taken across section 8B-8B of FIG. 8A;

FIG. 8C is cross sectional view of the connector of FIG. 8A taken across section 8C-8C of FIG. 8A;

FIG. 8D is a side view of a hybrid connector including portions having configurations according to FIGS. 7A and 8A;

FIG. 9 is an exploded perspective view of a multi-stack panel arrangement using the connector of FIG. 7D;

FIG. 10 is a perspective view of the multi-stack panel arrangement of FIG. 9 shown in an assembled state;

FIG. 11 is an exploded perspective view of a multi-stack panel arrangement using a hybrid connector having configurations according to FIGS. 3A and 8A;

FIG. 12 is a perspective view of the multi-stack panel arrangement of FIG. 11 shown in an assembled state;

FIG. 13 is an exploded perspective view of a multi-stack panel arrangement using a hybrid connector having configurations according to FIGS. 3A and 8A; and

FIG. 14 is a perspective of the multi-stack arrangement of FIG. 13 shown in a partially assembled state.

### DETAILED DESCRIPTION

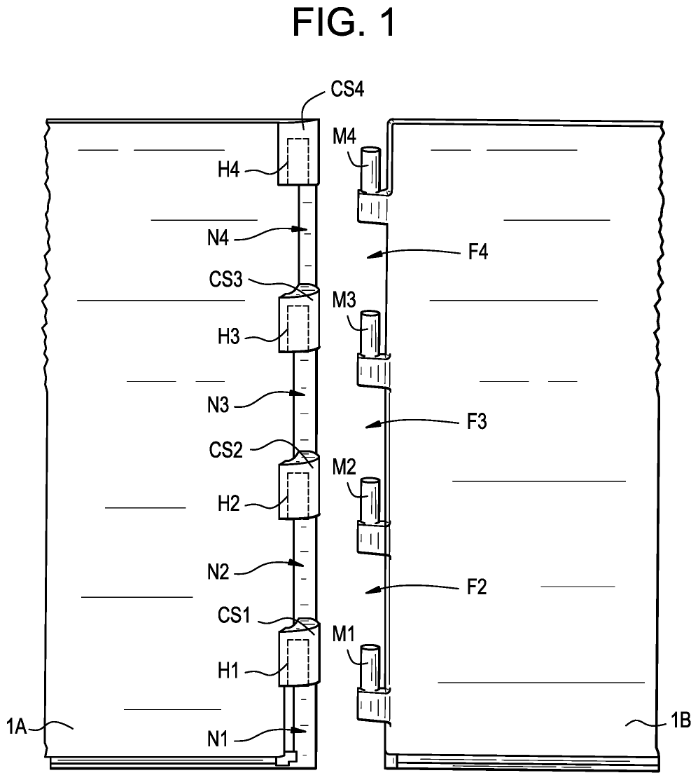

As shown in FIG. 1, a portion of a left side first-row perimeter component 1A (e.g., a hollow or solid plastic panel, a board or a sheet of material) and a right side first-row perimeter component 1B (e.g., a hollow or solid plastic panel with or without indentations, a board or a sheet of material) of a perimeter containment barrier of portable free-standing ice skating rink are shown separated from each other. The left side first-row perimeter component 1A is shown having four female panel connection sites CS1, CS2, CS3, CS4, each of which have an aperture H1, H2, H3, H4 extending axially therein from a bottom portion thereof and terminating before a top portion of the respective connection site CS1, CS2, CS3, CS4. Each of the female panel connection sites CS1, CS2, CS3, CS4 are axially spaced apart from one another by a recess N1, N2, N3, N4. The right side first-row perimeter component 1B is shown having four male panel connection sites M1, M2, M3, M4 that are spaced apart from one another by the distances F2, F3, F4.

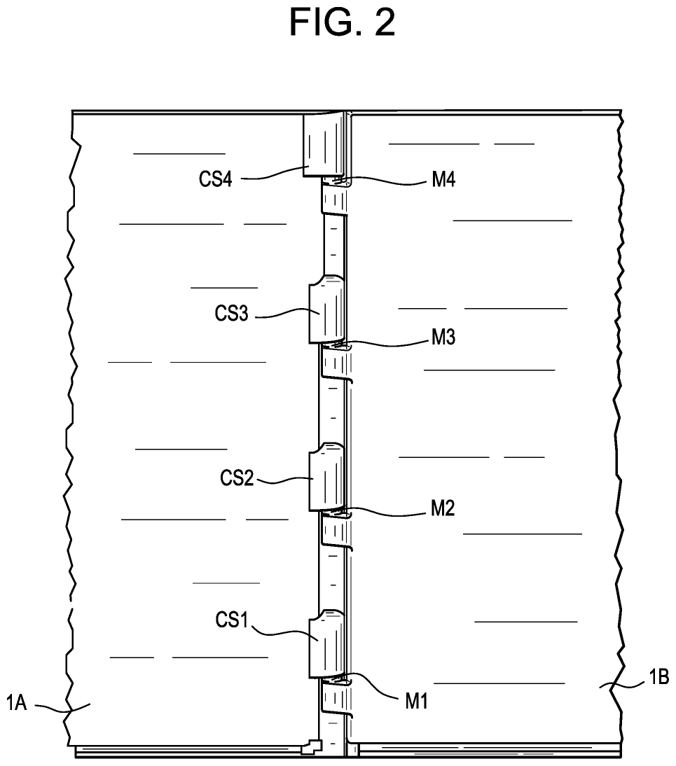

FIG. 2 illustrates the left side first-row perimeter component 1A secured to the right side first-row perimeter component 1B via connection of the respective male panel connection sites M1, M2, M3, M4 into the respective aperture H1, H2, H3, H4 of the respective female panel connection sites CS1, CS2, CS3, CS4.

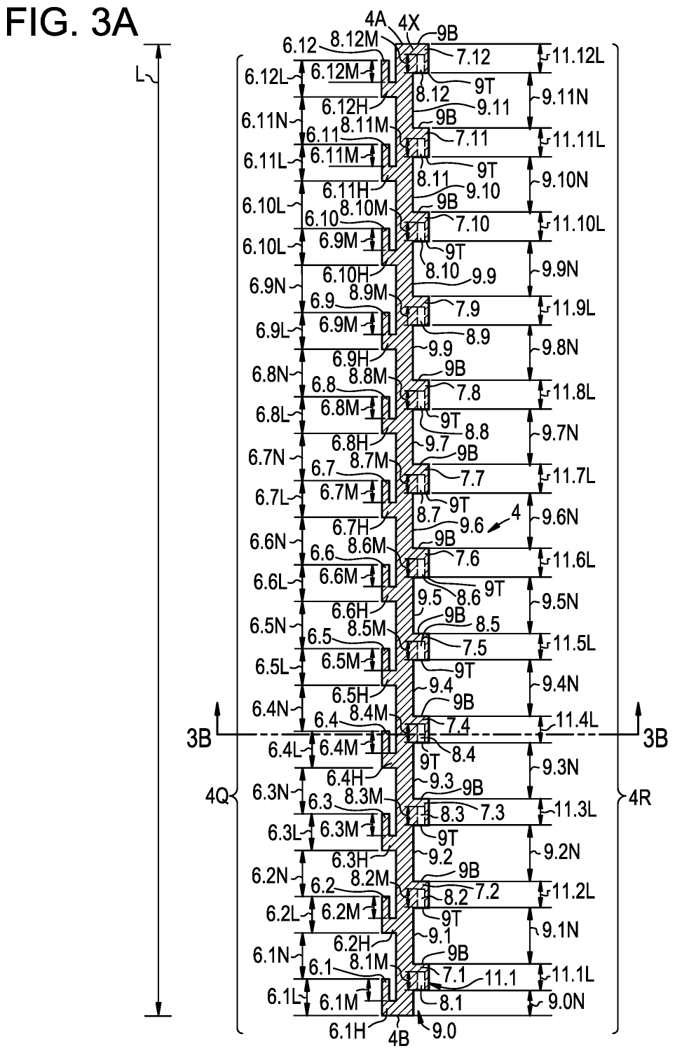

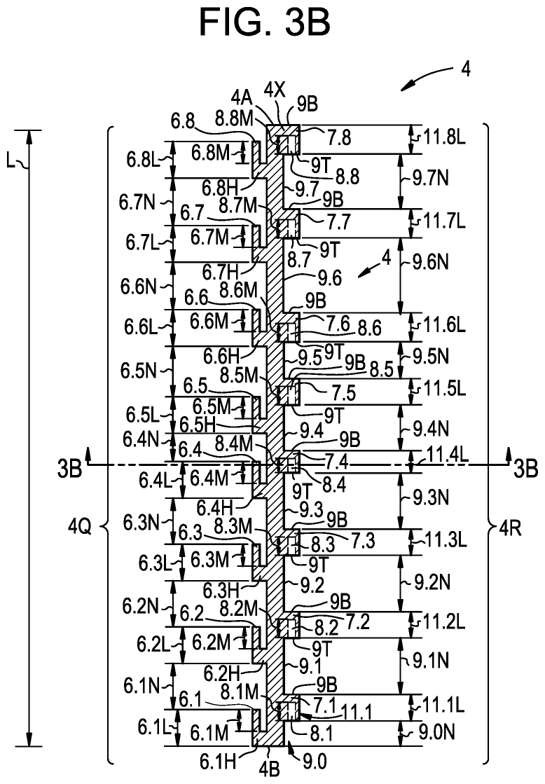

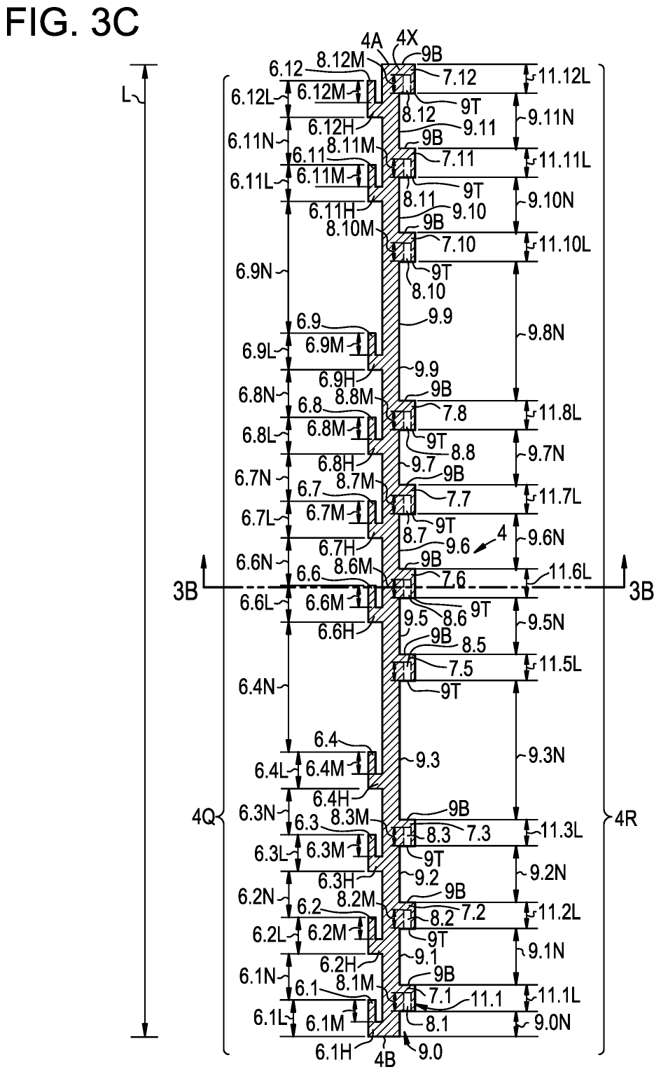

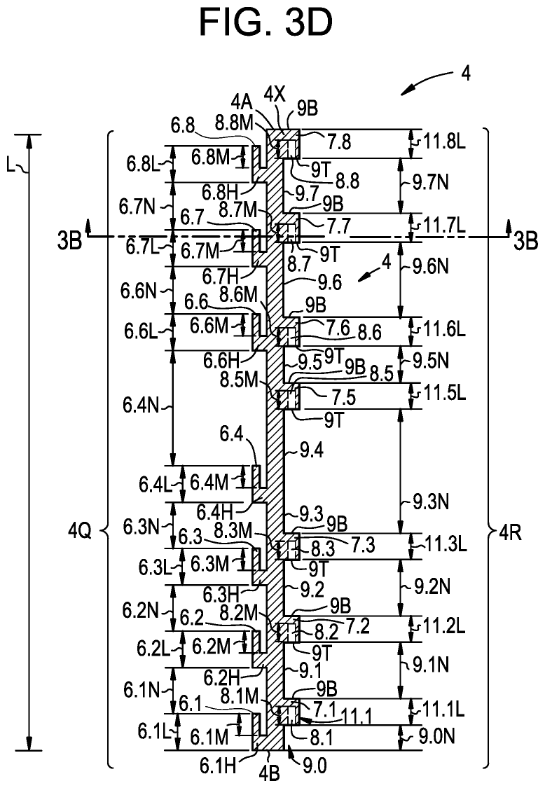

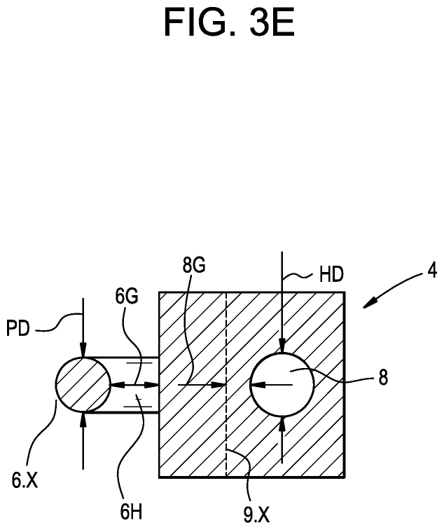

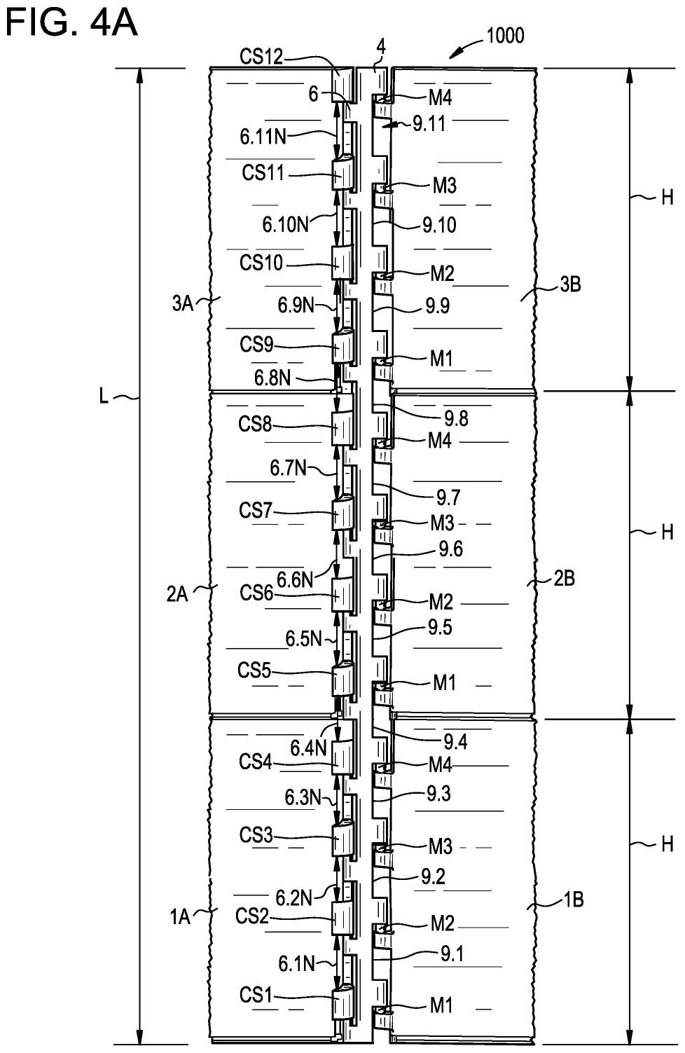

As shown in FIG. 3A a connector for removably securing and stacking perimeter components 1A, 1B of a portable self-standing skating rink is generally designated by the numeral 4. The connector 4 extends axially from a first axial end 4A (e.g., top end) to a second axial end 4B (e.g., bottom end). The connector 4 is an elongated body 4X that extends an overall length L from the first axial end 4A to the second axial end 4B thereof. The overall length L is selected to span across a height H of each of three perimeter components 1A, 2B; 2A, 2B; 3A, 3B (see FIG. 4A) that are stacked vertically upon one another. The connector 4 shown in FIG. 4A removably connects and vertically stabilizes three rows of the perimeter components, for example, a first row of perimeter components 1A, 1B, a second row of perimeter components 2A, 2B stacked vertically on top of the first row and a third row of perimeter components 3A, 3B stacked vertically on top of the second row. While the overall length L of the connector is shown and described as being selected to span across the height H of each of three perimeter components 1A, 2A; 1B, 2B; 2A, 3A, 2B 3B, the present invention is not limited in this regard as the overall length L may be of other magnitudes including but not limited to a length selected to span across (a) a height H of each of two perimeter components 1A, 2A; 1B, 2B, as shown in FIG. 3B (b) a height of more than three vertically stacked rows of perimeter components; or (c) a portion a height of one row of perimeter components and a portion of a height of a second row of perimeter components stacked vertically upon one another (see FIG. 4B).

As shown in FIG. 3A, the connector 4 includes two or more (e.g., twelve shown) first anchoring features 4Q each of which extend a length 6.1L, 6.2L, 6.3L, 6.4L, 6.5L, 6.6L, 6.7L, 6.8L, 6.9L. 6.10L, 6.11L, 6.12L into or along a first lateral side 4F of the elongated body 4X.

As shown in FIG. 3A, each of the first anchoring features 4Q includes a branch leg 6.1H, 6.2H, 6.3H, 6.4H, 6.5H, 6.6H, 6.7H, 6.8H, 6.9H, 6.10H, 6.11H, 6.12H each of which extend outwardly toward the first lateral side 4F of the elongated body 4X. Each of the branch legs 6.1H, 6.2H, 6.3H, 6.4H, 6.5H, 6.6H, 6.7H, 6.8H, 6.9H, 6.10H, 6.11H, 6.12H has a peg 6.1, 6.2, 6.3, 6.4, 6.5, 6.6, 6.7, 6.8, 6.9, 6.10, 6.11, 6.12 secured thereto and each of which extend axially away from the respective branch leg 6.1H, 6.2H, 6.3H, 6.4H, 6.5H, 6.6H, 6.7H, 6.8H, 6.9H, 6.10H, 6.11H, 6.12H towards the first axial end 4A. Each of the pegs 6.1, 6.2, 6.3, 6.4, 6.5, 6.6, 6.7, 6.8, 6.9, 6.10, 6.11, 6.12 are axially spaced apart from one another by an axial distance 6.1N, 6.2N, 6.3N, 6.4N, 6.5N, 6.6N, 6.7N, 6.8N, 6.9N, 6.10N, 6.11N.

As shown in FIG. 3A, the fourth peg 6.4 counting upwardly from the second axial end 4B and the fifth peg 6.5 counting upwardly from the second axial end 4B are spaced apart an axial distance 6.4N which is less the axial distance 6.1N, 6.2N, 6.3N, 6.5N, 6.6N, 6.7N, 6.9N, 6.10N and 6.11N. The eighth peg 6.8 counting upwardly from the second axial end 4B and the ninth peg 6.9 counting upwardly from the second axial end 4B are spaced apart an axial distance 6.8N which is less the axial distance 6.1N, 6.2N, 6.3N, 6.5N, 6.6N, 6.7N, 6.9N, 6.10N and 6.11N. Thus, two of the pegs 6.4, 6.5 are axially spaced apart from one another by a second axial distance 6.4N, 6.8N which is less than the first axial distance 6.1N, 6.2N, 6.3N, 6.5N, 6.6N, 6.7N, 6.9N, 6.10N and 6.11N. However, in some embodiments, all of the axial distances 6.1N, 6.2N, 6.3N, 6.4N, 6.5N, 6.6N, 6.7N, 6.8N, 6.9N, 6.10N, 6.11N have substantially equal magnitudes.

In some embodiments, the axial distance 6.4N and the axial distance 6.8N are substantially equal in magnitude. In some embodiments, the axial distance 6.4N and the axial distance 6.8N each have a magnitude of about 1.0 to 1.5 inches. In some embodiments, the axial distance 6.1N, 6.2N, 6.3N, 6.5N, 6.6N, 6.7N, 6.9N, 6.10N and 6.11N have substantially equal magnitudes. In some embodiments, the axial distance 6.1N, 6.2N, 6.3N, 6.5N, 6.6N, 6.7N, 6.9N, 6.10N and 6.11N each have a magnitude of about 2.25 to 2.75 inches.

In some embodiment, ten of the twelve pegs 6.1, 6.2, 6.3, 6.4, 6.6, 6.7, 6.8, 6.10, 6.11, 6.12 have an axial length 6.1N, 6.2N, 6.3N, 6.4N, 6.6N, 6.7N, 6.8N, 6.10N, 6.11N, 6.12N, respectively, that are substantially equal in magnitude. In some embodiment, each of the ten pegs 6.1, 6.2, 6.3, 6.4, 6.6, 6.7, 6.8, 6.10, 6.11, 6.12 has an axial length 6.1L, 6.2L, 6.3L, 6.4L, 6.6L, 6.7L, 6.8L, 6.10L, 6.11L, 6.12L, respectively, of about 2.25 to 2.75 inches. In some embodiment, two of the twelve pegs 6.5 and 6.9 has an axial length 6.5L and 6.9L, respectively, that are substantially equal in magnitude. In some embodiment, each of the two pegs 6.5 and 6.9 has an axial length 6.5L and 6.9L, respectively, of about 0.75 to 1.25 inches. However, in some embodiments, all of the lengths 6.1L, 6.2L, 6.3L, 6.4L, 6.5L, 6.6L, 6.7L, 6.8L, 6.9L. 6.10L, 6.11L, 6.12L of all twelve pegs 6.1, 6.2, 6.3, 6.4, 6.5 6.6, 6.7, 6.8, 6.9, 6.10, 6.11, 6.12 have substantially the same magnitude.

As shown in FIG. 3A, the connector includes two or more (e.g., twelve shown) second anchoring features 4R. Each of the second anchoring features 4R has a hub 7.1, 7.2, 7.3, 7.4, 7.5, 7.6, 7.7, 7.8, 7.9, 7.10, 7.11, 7.12 with a recess 9.1, 9.2, 9.3, 9.4, 9.5, 9.6, 9.7, 9.8, 9.9, 9.10, 9.11 formed between adjacent hubs in the second lateral side 4G of the elongated body 4X. Each of the recesses extend a first axial length 9.1N, 9.2N, 9.3N, 9.4N, 9.5N, 9.6N, 9.7N, 9.8N, 9.9N, 9.10, 9.11N between a first land 9B (i.e., top face) on one hub and a second land 9T (i.e., bottom face) of the adjacent hub. Each of the second lands 9T have an aperture (8.1, 8.2, 8.3, 8.4, 8.5, 8.6, 8.7, 8.8, 8.9, 8.10, 8.11, 8.12) extending vertically upward therein and terminating prior to the second land 9B. In some embodiments, the apertures 8.1, 8.2, 8.3, 8.4, 8.5, 8.6, 8.7, 8.8, 8.9, 8.10, 8.11, 8.12 are about 0.4 to 0.8 inches deep. Each of hubs 7.1, 7.2, 7.3, 7.4, 7.5, 7.6, 7.7, 7.8, 7.9, 7.10, 7.11, 7.12 extend a length 11.1L, 11.2L, 11.3L, 11.4L, 11.5L, 11.6L, 11.7L, 11.8L, 11.9L, 11.10L, 11.11L, 11.12L into or along a second lateral side 4G of the elongated body 4X. The second lateral side 4G faces opposite to the first lateral side 4F.

Ten of the second anchoring features 4R have axial lengths 11.1L, 11.2L, 11.3L, 11.5L, 11.6L, 11.7L, 11.9L, 11.10L, 11.11L, 11.12L. The axial lengths 11.4L, 11.8L of the fourth of the second anchoring features 4R, counting up from the second axial end 4B, and the eighth 12 of the second anchoring features 4R, counting up from the second axial end 4B, each are lesser in magnitude than the axial lengths 11.1L, 11.2L, 11.3L, 11.5L, 11.6L, 11.7L, 11.9L, 11.10L, 11.11L, 11.12L of the other ten second anchoring features 4R. However, in some embodiments, the lengths 11.1L, 11.2L, 11.3L, 11.4L, 11.5L, 11.6L, 11.7L, 11.8L, 11.9L, 11.10L, 11.11L, 11.12L of all twelve of the second anchoring features 4R have substantially the same magnitude.

As shown in FIG. 3A, each of the axial lengths 9.1N, 9.2N, 9.3N, 9.5N, 9.6N, 9.7N, 9.9N, 9.10N, 9.11N of nine of the eleven recesses 9 have substantially equal magnitudes. In some embodiments, each of the axial lengths 9.1N, 9.2N, 9.3N, 9.5N, 9.6N, 9.7N, 9.9N, 9.10N, 9.11N of nine of the eleven recesses 9 have a magnitude of about 3.0 to 3.25 inches. In some embodiments, all of the axial length 9.1N, 9.2N, 9.3N, 9.4N, 9.5N, 9.6N, 9.7N, 9.8N, 9.9N, 9.10N, 9.11N are substantially equal in magnitude. Each of the axial lengths 9.4N and 9.8N of two of the eleven recesses (i.e., the recess 9 between the fourth of the second anchoring features 4R, counting up from the second axial end 4B and the fifth the second anchoring features 4R, counting up from the second axial end 4B; and the recess 9 between the eight of the second anchoring features 4R, counting up from the second axial end 4B and the ninth of the second anchoring features 4R, counting up from the second axial end 4B) are of lesser magnitude than the remainder of the axial length 9.1N, 9.2N, 9.3N, 9.4N, 9.5N, 9.6N, 9.7N, 9.8N, 9.9N, 9.10N, 9.11N of the other nine recesses. However, in some embodiments, each of the axial lengths 9.1N, 9.2N, 9.3N, 9.4N, 9.5N, 9.6N, 9.7N, 9.8N, 9.9N, 9.10N, 9.11N of all eleven recesses 9 have substantially the same magnitude.

The connector 4 of FIG. 3B is similar to the connector 4 of FIG. 3A with the exception that the overall length L of the connector 4 of FIG. 3B is shorter than the overall length L of the connector 4 of FIG. 3A. In one embodiment, the overall length L of the connector 4 of FIG. 3B is about two thirds of the overall length L of the connector 4 of FIG. 3A, such that the connector 4 of FIG. 3B is configured to span across two rows of perimeter components 1A, 1B; 2A, 2B.

The connector 4 shown in FIG. 3C is similar to the connector 4 of FIG. 3A with the exception that the connector 4 of FIG. 3C has only ten first anchoring features 4Q each of which extend a length 6.1L, 6.2L, 6.3L, 6.4L, 6.6L, 6.7L, 6.8L, 6.10L, 6.11L, 6.12L of the ten pegs 6.1, 6.2, 6.3, 6.4, 6.6, 6.7, 6.8, 6.10, 6.11, 6.12, respectively. In other words, pegs 6.5 and 6.9 of the connector 4 of FIG. 3A are not present in the connector 4 of FIG. 3C. The two pegs 6.4 and 6.6 are axially spaced apart from one another by a second axial distance 6.4N which is greater than the first axial distance 6.1N, 6.2N, 6.3N, 6.6N, 6.7N, 6.8N, 6.11. The two pegs 6.9 and 6.10 are axially spaced apart from one another by a second axial distance 6.9N which is greater than the first axial distance 6.1N, 6.2N, 6.3N, 6.6N, 6.7N, 6.8N, 6.11. In some embodiments, the lengths 6.4N and 6.9N are each about five to seven inches.

In addition, the connector 4 shown in FIG. 3C is different than the connector 4 of FIG. 3A in that the connector 4 of FIG. 3C has only ten second anchoring features 4R each of which extend a length 11.1L, 11.2L, 11.3L, 11.4L, 11.5L, 11.6L, 11.7L, 11.8L, 11.9L, 11.10L, 11.11L, 11.12L into or along a second lateral side 4G of the elongated body 4X. The recess 9.3 between the second anchoring feature 4R that is the third counting upwards from the second axial end 4B and the second anchoring feature 4R that is the fourth counting upwards from the second axial end 4B has a length 9.3N that is greater than any one of the lengths 9.1N, 9.2N, 9.5N, 9.6N 0.7N, 9.10N, and 9.11N. The recess 9.3 between the second anchoring feature 4R that is the seventh counting upwards from the second axial end 4B and the second anchoring feature 4R that is the eighth counting upwards from the second axial end 4B has a length 9.8N that is greater than any one of the lengths 9.1N, 9.2N, 9.5N, 9.6N, 9.7N, 9.10N, and 9.11N. In some embodiments, the length 9.3N and the length 9.8N are each about 5 to 7 inches.

FIG. 4B illustrates an embodiment in which a truncated connector is employed. The truncated connector 4 is similar to the connector of FIG. 3A but is shorter in overall length LL. One of the truncated connectors 4 joins the first row of perimeter components 1A, 1B with the second row of perimeter components 2A, 2B stacked thereon. Another of the truncated connectors 4 joins the second row of perimeter components 2A, 2B with the third row of perimeter components 3A, 3B stacked thereon.

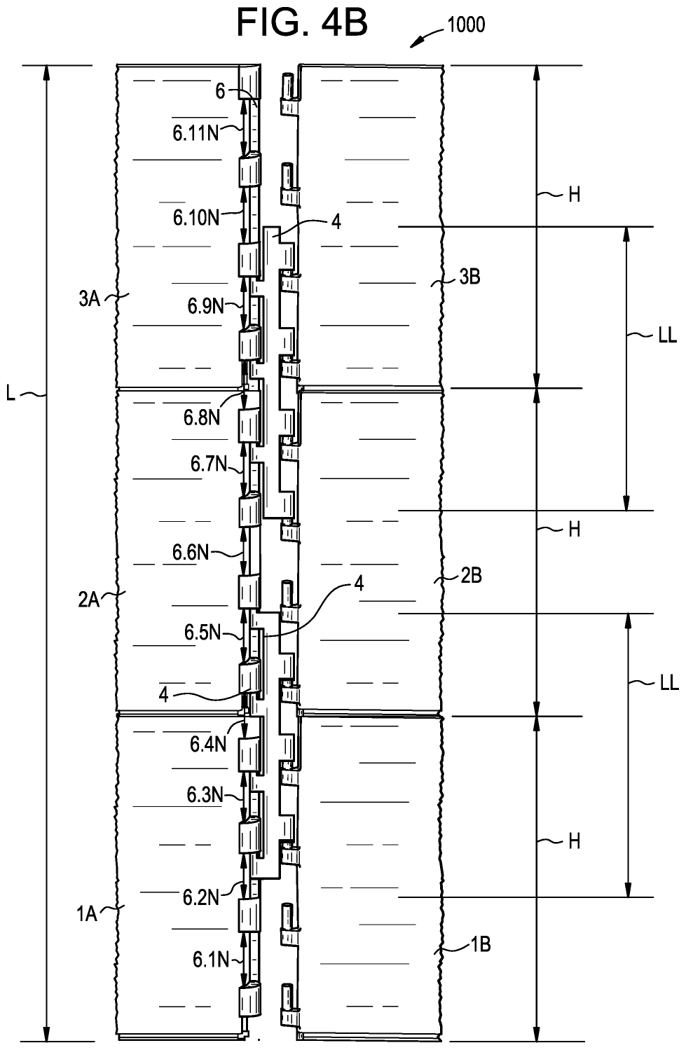

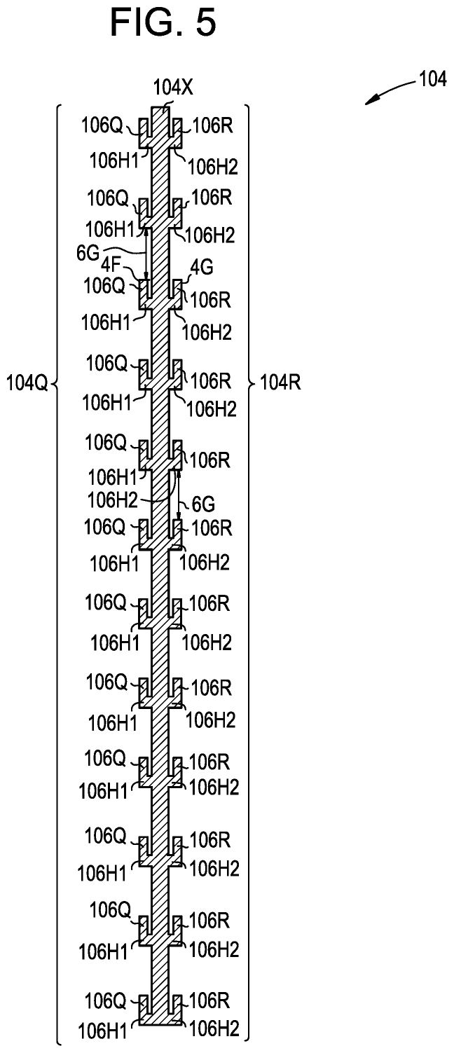

The connector 104 of FIG. 5 is similar to the connector 4 of FIG. 3A except that the connector 104 has first anchor features with the pegs on both the first lateral face 4F and the second lateral face 4G. As shown in FIG. 5, each of the first anchoring features 104Q has a first branch leg 106H1 that extends outwardly from the first lateral side 4F of the elongated body 104X. Each of the first branch legs 106H1 has a first peg 106Q secured thereto and extending axially away therefrom. Each of the first pegs 106Q is spaced apart from one another by a distance 6G. As shown in FIG. 5, each of the second anchoring features 104R includes a second branch leg 106H2 that extends outwardly from the second lateral side 4G of the elongated body 104X. Each of the second branch legs 106H2 has a second peg 106R secured thereto and extending axially away therefrom. Each of the second pegs 106R is spaced apart from one another by the axial distance 6G.

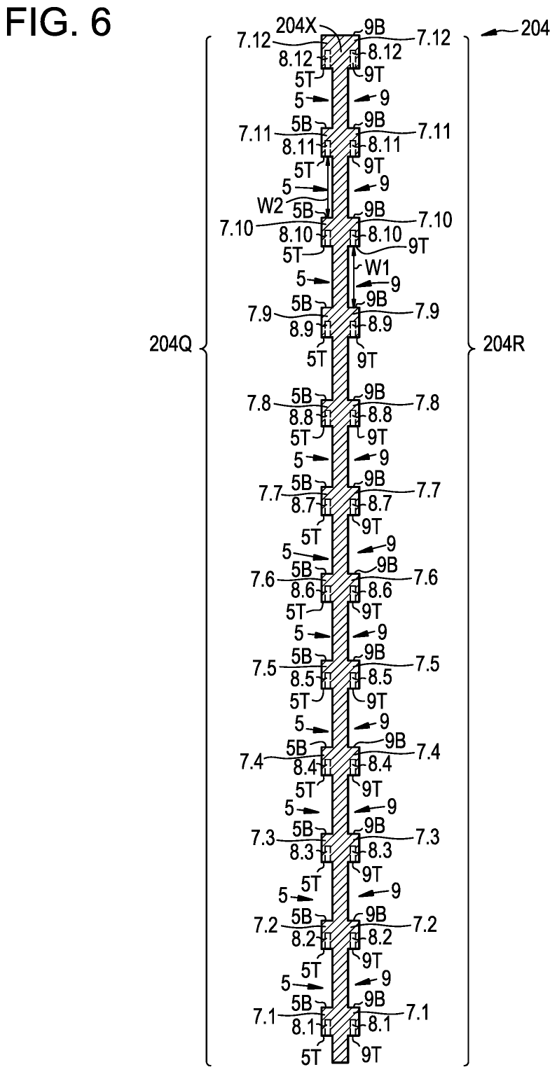

The connector 204 of FIG. 6 is similar to the connector 4 of FIG. 3A except that the connector 204 has second anchor features 204Q with the hubs 7.1, 7.2, 7.3, 7.4, 7.5, 7.6, 7.7, 7.8, 7.9, 7.10, 7.11, 7.12 on both the first lateral face 4F and the second lateral face 4G. As shown in FIG. 6, each of the at first anchoring features 204Q includes a first recess 5 formed in the first lateral side 4F of the elongated body 204X. Each of the first recesses 5 extends a first length W2 between a first land 5B of one of the first anchoring features 204Q and a second land 5T of an adjacent one of the first anchoring features 4Q. As shown in FIG. 6, each of the second anchoring features 204R includes a second recess 9 formed in the second lateral side 4G of the elongated body 204X. Each of the second recesses 9 extends a second length W1 between a first land 9B of one of the second anchoring features 204R and a second land 9T of an adjacent one of the second anchoring features 204R. Each of the second lands 9T of the second anchoring feature 4R has an aperture 8 extending vertically upward towards the first axial end therein and terminating prior to the first land 9B.

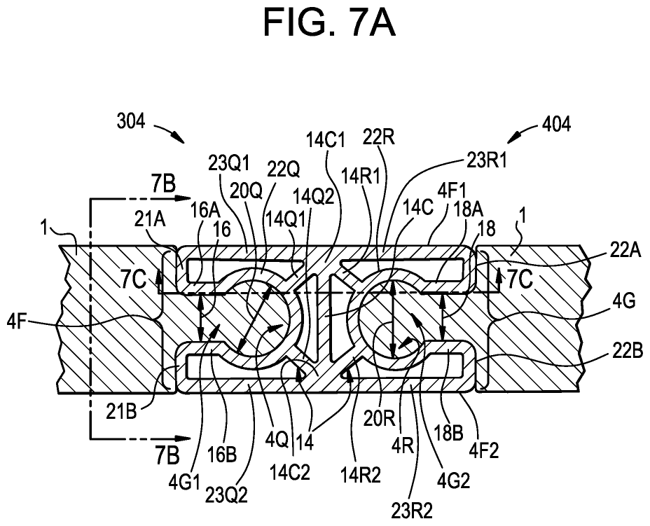

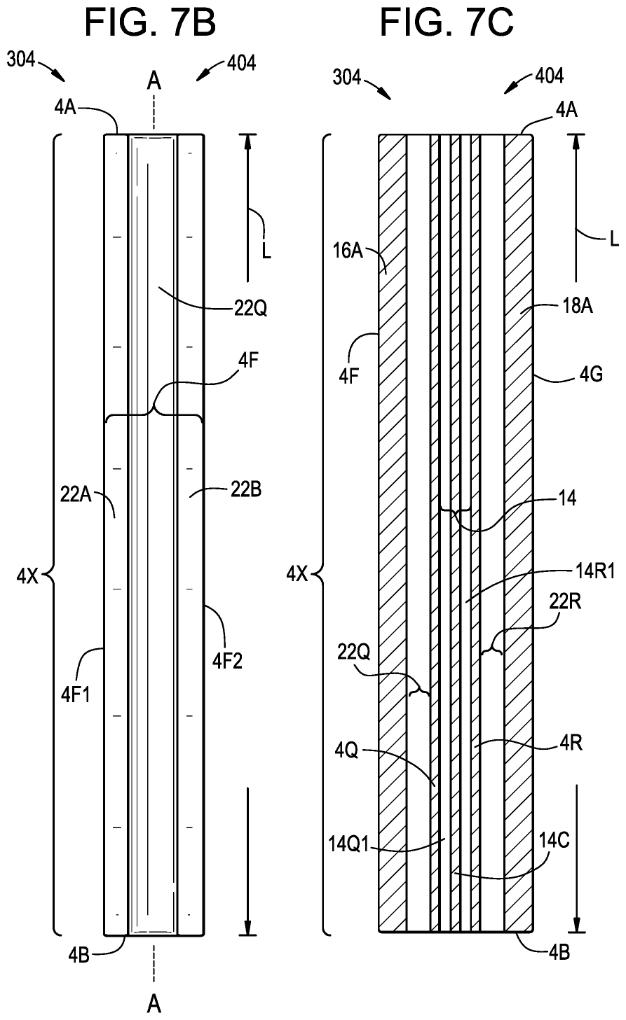

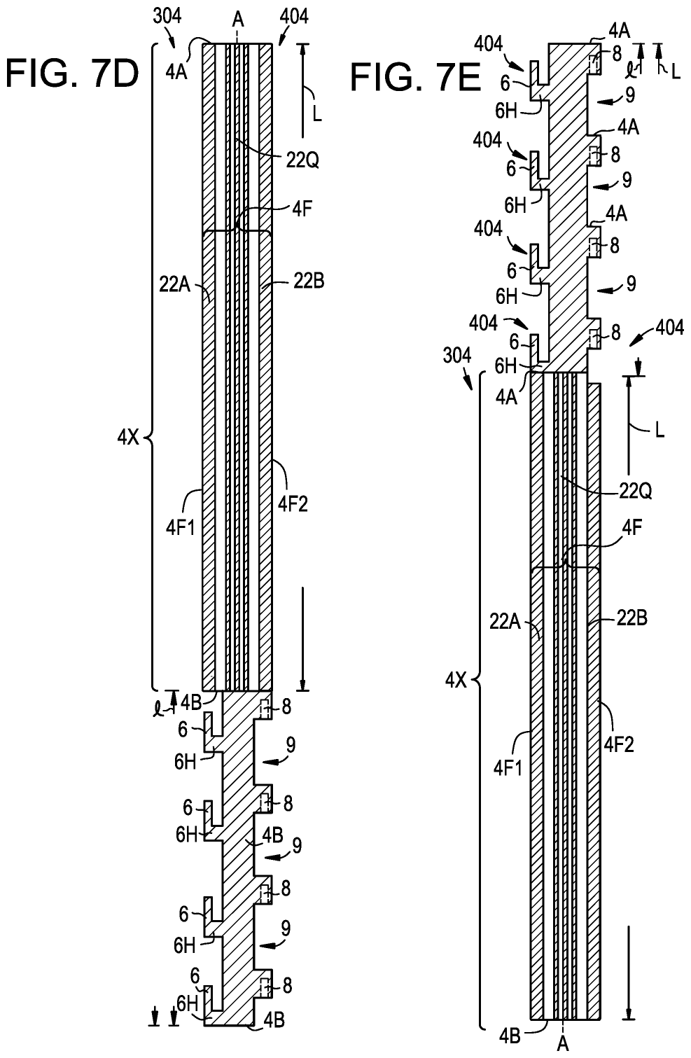

As shown in FIG. 7D, the connector 304 is a hybrid configuration of the connector 4 of FIG. 3A located on the bottom one third (i.e., the portion extending from the second axial end 4B of the connector 304) and first and second grooves 4G1 and 4G2 (see FIG. 7A), respectively, extending along and into the first lateral face 4F and the second lateral face 4G on the top (i.e., the portion extending from the first axial end 4A) two thirds of the connector 304.

As shown in FIG. 7E, the connector 304 is a hybrid configuration of the connector 4 of FIG. 3A located on the top one third (i.e., the portion proximate the first axial end 4A of the connector 304) and first and second grooves 4G1 and 4G2 (see FIG. 7A), respectively, extending along and into the first lateral face 4F and the second lateral face 4G on the bottom (i.e., the portion extending from the second axial end) two thirds of the connector 304.

As shown in FIG. 7A, the first groove 4G1 includes a first slot 16 defined by a first pair of opposing walls 16A, 16B, and the second groove 4G2 includes a second slot 18 defined by a second pair of opposing walls 18A, 18B. The first slot 16 extends inwardly from the first lateral side 4F towards the second slot 18, and the second slot 18 extends inwardly from the second lateral side 4G towards the first slot 16. The first groove 4G1 includes a first area of increased cross-section 20Q that extends inwardly from the first slot 16, and the second groove 4G2 includes a second area of increased cross-section 20R that extends inwardly from the second slot 18.

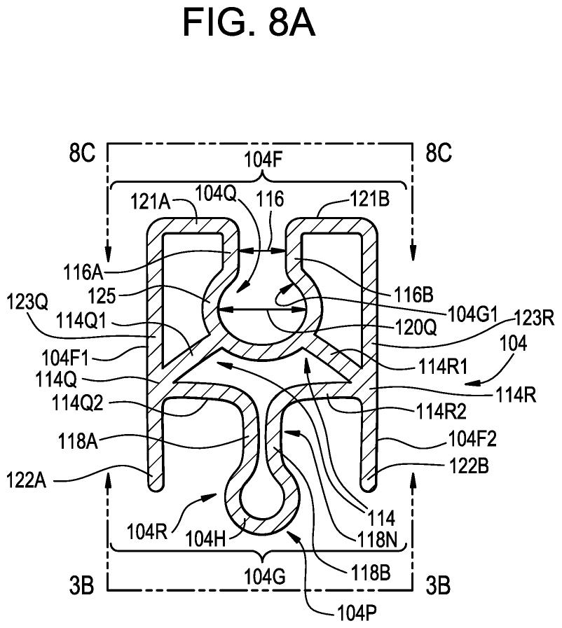

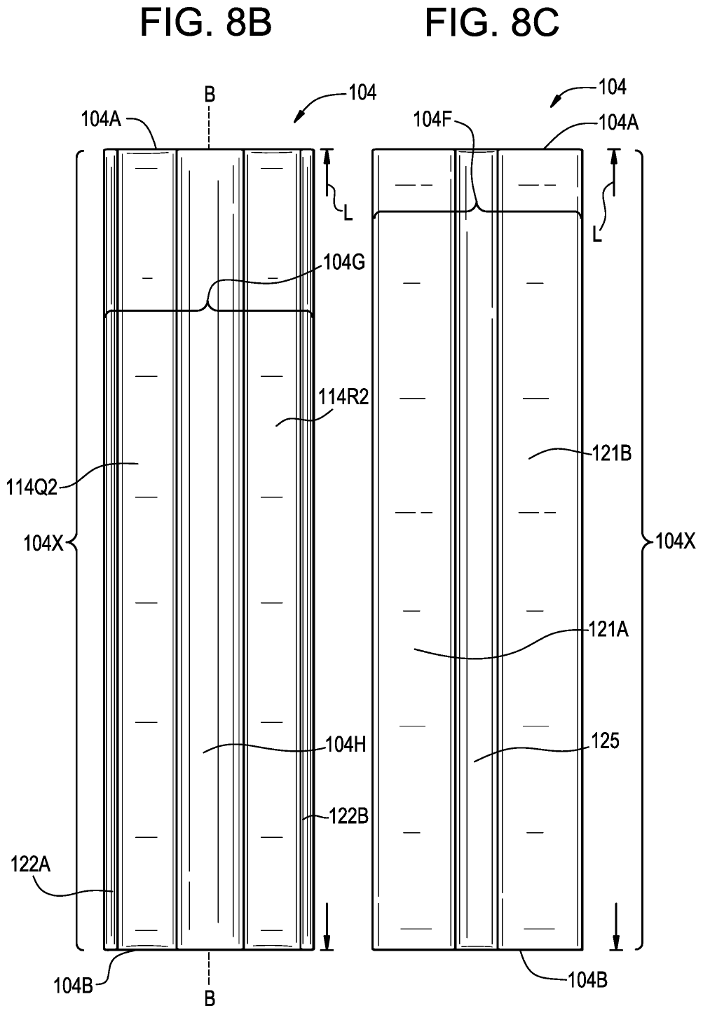

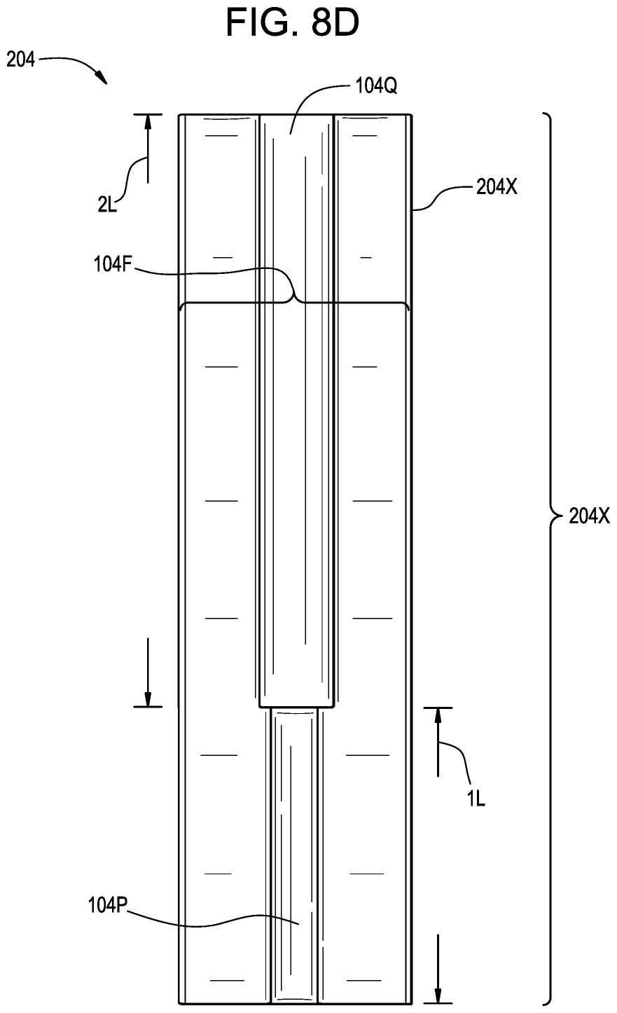

As shown in FIG. 8A, the connector 104 the first anchoring feature 4Q includes a groove 104G1 along a first portion 2l, of the length L, and the second anchoring feature 104R comprises a protuberance 104P that is positioned opposite the groove 104G1 along a second portion l of the length L. In some embodiments the connector 104 of FIG. 8A is employed on the upper or lower one third or two thirds of the connectors shown in FIGS. 7D and 7E, in place of the portions of the connector configured like FIG. 7A. As shown in FIG. 8A, the groove 104G1 includes a slot 116 defined by a first pair of opposing walls 116A, 116B, and the protuberance 104P includes a necked-in area 118N defined by a second pair of opposing walls 118A, 118B that terminate in a bulbous head 104H. The slot 116 extends inwardly from the first lateral side 104F towards the protuberance 104P and the protuberance 104P extends outwardly away from the slot 116.

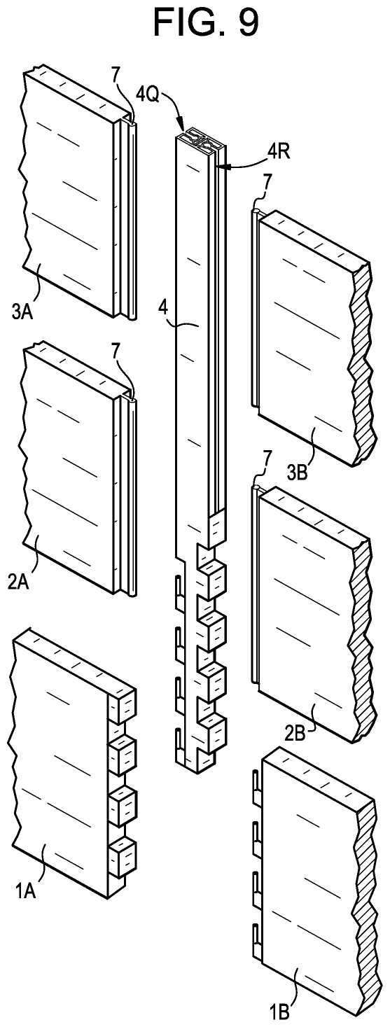

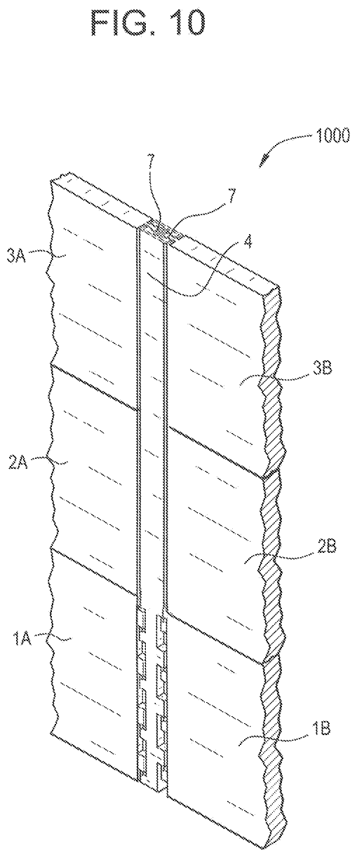

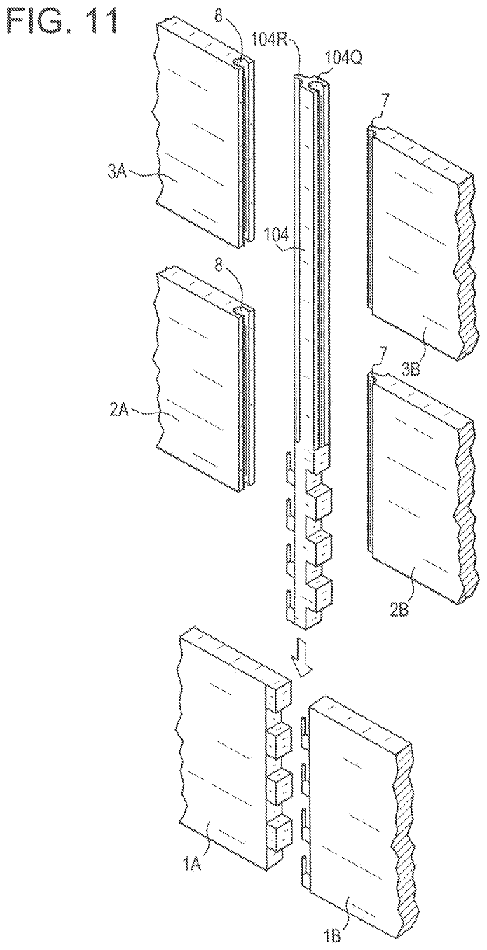

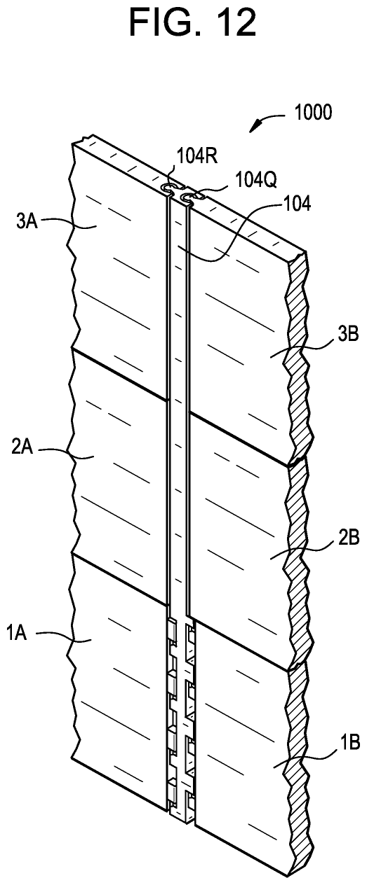

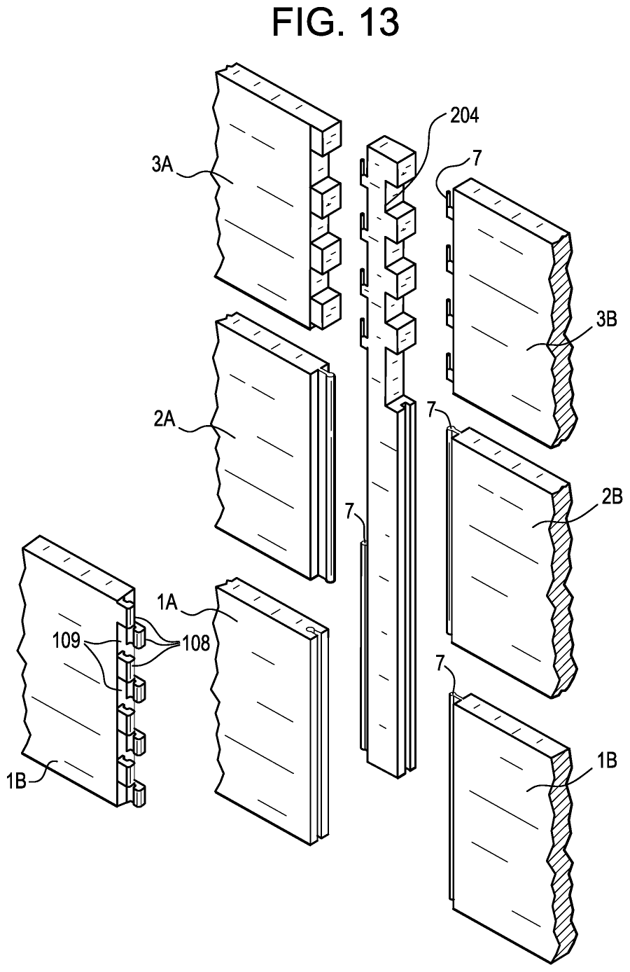

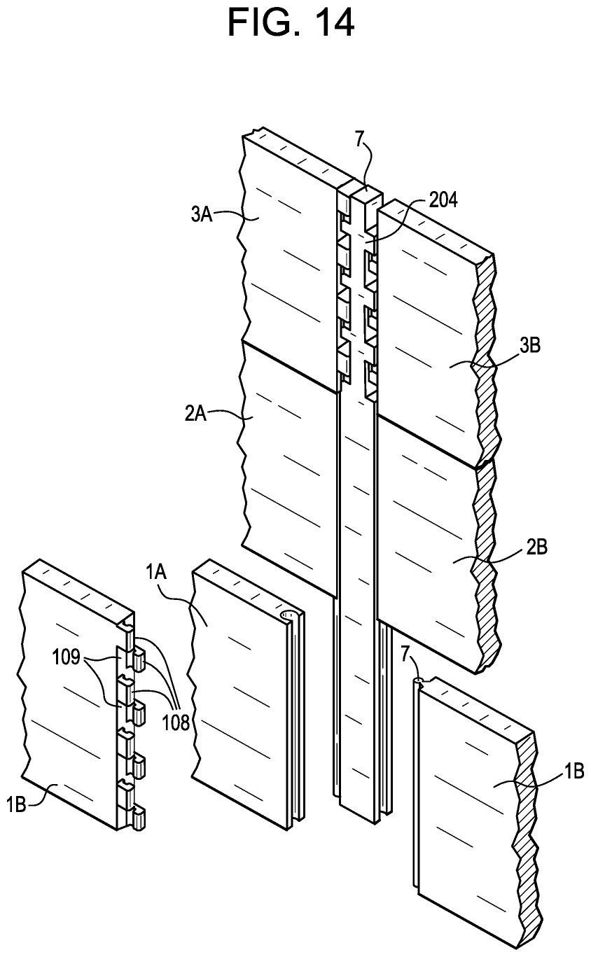

As shown in FIGS. 4A, 4B and 9-14 a multi-stacked perimeter assembly 1000 for a skating rink includes a connector of any of FIGS. 3A, 3B, 3C, 3D, 3E, 5-8D employed to removably join and vertically stabilize a first pair of perimeter components, a second pair of perimeter components 2A, 2B stacked on top of the first pair of perimeter components 1A and a third pair of perimeter components 3A, 3B stacked on top of the second pair of perimeter components 2A, 2B. The overall length L of the connectors 4, 104, 204 is at least two times a height H (e.g., 18 inches) of any of the first pair of perimeter components 1A, 1B, the second pair of perimeter components 2A, 2B and the third pair of perimeter components 3A, 3B. In some embodiments, the overall length L of the connectors 4, 104, 204 is about 54 inches. In the embodiment shown in FIG. 4B the connector 4 has a length LL that is less than the height H of the individual perimeter components.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A connector for removably securing and stacking perimeter components of a skating rink, the connector comprising:
an elongated body extending an overall length from a first axial end to a second axial end thereof, the overall length being selected to span across at least a portion of each of at least two perimeter components;
at least two first anchoring features each extending at least a portion of the length into or along a first lateral side of the elongated body; and
at least two second anchoring features each extending at least a portion of the length into or along a second lateral side of the elongated body, the second lateral side facing opposite to the first lateral side.

2. The connector of claim 1, wherein:
each of the at least two first anchoring features comprises a branch leg extending outwardly from the first lateral side of the elongated body, each of the branch legs having a peg secured thereto and extending axially away therefrom, each of the pegs being axially spaced apart from one another by a first axial distance; and
each of the at least two the second anchoring features comprises a hub with a recess formed between adjacent hubs in the second lateral side of the elongated body, each of the recesses extending first axial length between a first land and a second land of the adjacent hubs, each of the second lands having an aperture extending therein.

3. The connector of claim 2, further comprising at least three first anchoring features, wherein at least two of the pegs being axially spaced apart from one another by a second axial distance which is less than the first axial distance.

4. The connector of claim 2, further comprising at least three second anchoring features, wherein at least one of the recesses has a second axial length that is less than the first axial length.

5. The connector of claim 2, further comprising at least three first anchoring features, wherein at least two of the pegs being axially spaced apart from one another by a second axial distance which is greater than the first axial distance.

6. The connector of claim 2, further comprising at least three second anchoring features, wherein at least one of the recesses has a second axial length that is greater than the first axial length.

7. The connector of claim 1, wherein:
each of the at least two the first anchoring features comprises a first branch leg extending outwardly from the first lateral side of the elongated body, each of the first branch legs having a first peg secured thereto and extending axially away therefrom, each of the first pegs being spaced axially apart from one another by an axial distance; and
each of the at least two the second anchoring features comprises a second branch leg extending outwardly from the second lateral side of the elongated body, each of the second branch legs having a second peg secured thereto and extending axially away therefrom, each of the second pegs being spaced apart from one another by the axial distance.

8. The connector of claim 1, wherein:
each of the at least two the first anchoring features comprises a hub with a recess formed between adjacent hubs in the second lateral side of the elongated body, each of the recesses extending first axial length between a first land and a second land of the adjacent hubs, each of the second lands having an aperture extending therein;
each of the at least two the second anchoring features comprises a hub with a recess formed between adjacent hubs in the second lateral side of the elongated body, each of the recesses extending first axial length between a first land and a second land of the adjacent hubs, each of the second lands having an aperture extending therein.

9. The connector of claim 2, wherein the first anchoring feature further comprises a first groove along another portion of the length, and the second anchoring feature comprises a second groove along another portion of the length.

10. The connector of claim 9, wherein the first groove comprises a first slot defined by a first pair of opposing walls, and the second groove comprises a second slot defined by a second pair of opposing walls, and wherein the first slot extends inwardly from the first lateral side towards the second slot, and the second slot extends inwardly from the second lateral side towards the first slot.

11. The connector of claim 10, wherein the first groove comprises a first area of increased cross-section that extends inwardly from the first slot, and the second groove comprises a second area of increased cross-section that extends inwardly from the second slot.

12. The connector of claim 2, wherein the first anchoring feature comprises a groove along a first portion of the length, and the second anchoring feature comprises a protuberance that is positioned opposite the groove along a second portion of the length.

13. The connector of claim 12, wherein the groove comprises a slot defined by a first pair of opposing walls, and the protuberance comprises a necked-in area defined by a second pair of opposing walls that terminate in a bulbous head, wherein the slot extends inwardly from the first lateral side towards the protuberance, and the protuberance extends outwardly away from the slot.

14. The connector of claim 12, wherein the second portion is equal to about one third of the length of the elongated body, and the first portion is equal to about two thirds of the length of the elongated body.

15. A connector for removably securing and stacking perimeter components of a skating rink, the connector comprising:
an elongated body;
a plurality of branch legs extending outwardly from a first longitudinal portion of the elongated body, each of the branch legs having a peg secured thereto and extending away from the respective branch leg longitudinally with respect to the elongated body, each of the pegs being longitudinally spaced apart from one another along the elongated body; and
a groove longitudinally formed in a second longitudinal portion of the elongated body.

16. The connector of claim 15, further comprising a plurality of recesses formed in the first longitudinal portion of the elongated body, each of the recesses extending between a first land and a second land extending from the longitudinal body, the second land having an aperture extending therein.

17. The connector of claim 15, further comprising another plurality of other branch legs extending outwardly from the first longitudinal portion of the elongated body, each of the other branch legs having another peg secured thereto and extending away from the respective other branch leg longitudinally with respect to the elongated body, each of the other pegs being longitudinally spaced apart from one another along the elongated body.

18. The connector of claim 15, further comprising a protuberance extending longitudinally along the elongated body on the second longitudinal portion of the elongated body.

19. The connector of claim 15, further comprising another groove formed in the second longitudinal portion of the elongated body.

20. The connector of claim 15, wherein the first longitudinal portion and the second longitudinal portion make up an entire length of the elongated body.

21. A connector for removably securing and stacking perimeter components of a skating rink, the connector comprising:
an elongated body;
a plurality of branch legs extending outwardly from a first longitudinal portion of the elongated body, each of the branch legs having a peg secured thereto and extending away from the respective branch leg longitudinally with respect to the elongated body, each of the pegs being longitudinally spaced apart from one another along the elongated body; and
a protuberance extending longitudinally along the elongated body on a second longitudinal portion of the elongated body.

22. A connector for removably securing and stacking perimeter components of a skating rink, the connector comprising:
an elongated body;
a plurality of recesses formed in a first longitudinal portion of the elongated body, each of the recesses extending between a first land and a second land extending from the longitudinal body, the second land having an aperture extending therein; and
a groove longitudinally formed in a second longitudinal portion of the elongated body.

23. A connector for removably securing and stacking perimeter components of a skating rink, the connector comprising:
an elongated body;
a plurality of recesses formed in a first longitudinal portion of the elongated body, each of the recesses extending between a first land and a second land extending from the longitudinal body, the second land having an aperture extending therein; and
a protuberance extending longitudinally along the elongated body on a second longitudinal portion of the elongated body.

24. A multi-stacked perimeter assembly for a skating rink, the assembly comprising:
a connector of claim 1;
a first pair of perimeter components removably joined by the connector; and
a second pair of perimeter components stacked on top of the first pair of perimeter components and removably joined by the connector.

25. The multi-stacked perimeter assembly of claim 24, further comprising:
a third pair of perimeter components stacked on top of the second pair of perimeter components and removably joined by the connector.

26. The multi-stacked perimeter assembly of claim 24, wherein the length of the connector is at least two times a height of any of the first pair of perimeter components, the second pair of perimeter components and the third pair of perimeter components.

27. The multi-stacked perimeter assembly of claim 24, further comprising a connector of claim 1 removably joining adjacent perimeter components.
